(19) United States
(12) Patent Application Publication
(10) Pub. No.: US 2024/0337073 A1
(43) Pub. Date: Oct. 10, 2024

(54) PRINTABLE MODULAR FLOOR TILES

(71) Applicant: RECREATIONAL SYSTEMS INTERNATIONAL B.V., VALKENSWAARD (NL)

(72) Inventors: Hans Marcel Martha BORGERS, Valkenswaard (NL); Arnoud Frederik FIOLET, Valenswaard (NL)

(21) Appl. No.: 18/293,681

(22) PCT Filed: Sep. 1, 2022
(86) PCT No.: PCT/NL2022/050497

§ 371 Date: Jan. 30, 2024

(30) Foreign Application Priority Data
Sep. 1, 2021 (NL) 2029096
Apr. 8, 2022 (NL) 2031546

(51) Int. Cl. E01C 13/04; G09F 23/00

(52) U.S. Cl. CPC E01C 13/045; G09F 23/0066

(57) ABSTRACT

The present invention generally relates to a floor tile arranged for use as a construction element for the manufacture of a field such as a sports or playing field, the floor tile comprising a main face which is oriented upwards after manufacture of the field and is visible to users of the field, wherein the floor tile is a plastic floor tile and on the main face is provided with a graphic layer which is arranged to provide marking lines, logos, graphics or coloring of the floor tile, the graphic layer comprising UV ink, as well as a protective coating applied to the graphic layer, the protective coating comprising a two-component polyurethane coating provided with nonskid means, wherein the main face has been pre-treated by means of a corona treatment.

The present inventive relates in general to printable modular floor tiles.

Such floor tiles are designed for use as a construction element for the manufacture of a field such as a sports or playing field. These have been specially developed for outdoor use, but can also be applied indoors. The tiles have a standard shape and dimensions which allows easy application as a construction element for construction of a sports field or a playing field.

In the context of the present description, a floor tile is understood to mean a tile that is suitable for a wide range of applications, including but explicitly not limited to use in sports and playing fields. The floor tiles are also suitable for all types of tile solutions, such as application as a garage floor, sports floor in a fitness center, indoor sports location, but also as technical floor tiles for constructing floors for exhibitions, trade fairs, etc. In the present description, however, reference will be made to the application as sports field by way of example.

Characteristic of the floor tiles is that they have very good properties for the practice of sports and games. For example, the floor tiles are shock-resistant and wear-resistant which makes them very durable. With this, the tiles offer a good resilience to athletes, while the ball behavior is also experienced as very positive.

Floor tiles, and in particular sports tiles, can be used for a wide variety of sports, including football, tennis, volleyball and basketball. Because the floor tiles are made of a plastic material, they can easily be produced in a wide variety of colors. This gives an opportunity to make sports fields in nearly all colors and additionally to apply various color blocks to differentiate certain parts of the field or make a single field suitable for multiple sports. It is also easy to apply field marking lines on such floor tiles.

Presently known floor tiles are provided with color by adding a color pigment to the plastic base material during the production process. As a result, the material of the floor tile will be colored through and through. This has the advantage that with intensive use and some wear of the floor tile, no fading of the color can occur.

However, it also has a disadvantage to color the floor tiles as such because it is not easy to provide more than one color. Specifically, the application of more complex graphics, such as clearly contrasting lines or other graphic elements, should be applied in a different way.

It is known to apply such graphics using a printing technique. However, the printing technique has the disadvantage that it is considerably less durable than a floor tile whose plastic material is colored through and through. With intensive use, the image will fade, the applied printed layer will partially or completely peel off or the color of the print may start to bleed.

There is therefore a need for an improved floor tile suitable for use as a construction element for the manufacture of a sports field or playing field which is suitable for a robust, durable applied graphic image.

Therefore, according to a first aspect of the present description a floor tile is provided which is arranged for use as a construction element for the manufacture of a field such as a sports or playing field, the floor tile comprising a main face which is oriented upwards after manufacture of the field and visible to users of the field, wherein the floor tile is a plastic floor tile and is provided with a graphic layer on the main face arranged to provide lines, logos, graphics or coloring of the tile, the graphic layer comprising UV ink, as well as a protective coating applied to the graphic layer, the protective coating comprising a two-component polyurethane coating provided with nonskid means, wherein the main face has been pre-treated by means of a corona treatment.

The floor tile according to the present description is made of a plastic material. That plastic material can be new or virgin plastic, or recycled plastic. However, in a preferred embodiment it comprises both virgin and recycled plastic.

The plastic is provided as base material, for instance in granular or granulate form, after which it is melted into a viscous mass which is injected under pressure into a mold. The mold includes a cavity which has the shape of the floor tile. After the plastic has cooled down, the floor tile is ready.

Masterbatch can be added to the floor tile as an additive for coloring the plastic, in particular color masterbatch. By adding the masterbatch, the color pigment improves and the pigment will decrease in material size, resulting in better mixing of the color, better color strength and greater color depth.

Also other additives can be added to the plastic material of the floor tile, for instance to improve the stability of the plastic material and the color in particular. For example, a UV protector can be added to prevent degradation by UV light. Additional stabilizers or resins can also be added to further increase the stability of the plastic.

The base material of the plastic is preferably polyethylene or polypropylene, which as such are materials known for manufacturing these floor tiles. The floor tiles can be manufactured in different sizes, shapes and colors so that they are suitable for a wide variety of sports and games. In addition, floor tiles of different sizes, shapes and colors can be combined in one and the same field.

An important part of the floor tile is the applied marking lines or other graphic elements for indications in the game played on the field. These marking lines should usually only concern a part of the surface of the floor tile. As a result, it is often not possible to use differently colored floor tiles that are provided entirely in a single color, in order to indicate the marking lines.

These graphic elements such as marking lines must therefore be applied with a printing technique. However, presently known printing techniques are not durable and with average to intensive use of the floor tiles, the graphic print will fade, peel off and possibly start to bleed.

Since such floor tiles, when used for sports and games applications, must provide considerable grip to the players, the major surface of the floor tile should provide at least some friction. This is possible, for example, by applying a structure such as a repeating or random pattern of small bulges or depressions. Moreover, the application of the graphic layer can further reduce the friction, creating an even greater need to improve these properties.

The use of currently known nonskid material such as sand by applying it in the color or graphic layer has the further disadvantage that wearing of the coloring or the print will occur even faster as a result.

The inventors have realized that because of this a different kind of color layer but also an additional coating must be applied that can protect the print. On the one hand, this coating must be sufficiently rigid to offer sufficient resistance to wear of the underlying print, but on the other hand it should add sufficient friction so that the requirements demanded of such sports and also playing fields can be met.

The floor tiles according to the present description comprise a print or graphic layer applied with UV ink. This technique concerns a UV ink printing technique and is able to apply all colors in a high resolution on a variety of surfaces using six basic colors: black, cyan, light cyan, magenta, light magenta, yellow and white. This also includes the materials from which the floor tiles are made, namely polypropylene or polyethylene. After the ink has been applied, it is cured by a UV lamp, which is in particular an LED UV lamp, after which the ink is immediately dry. This technique is also particularly suitable for printing on uneven surfaces, making it possible to print on a floor tile with relief or even a pattern of water-permeable holes.

In order to obtain a better adhesion of the UV ink to the plastic of the floor tile, the surface of the floor tile is first treated with a corona treatment. A corona treatment is an electrochemical treatment to modify the surface properties of plastics. Many plastics have a chemically inert and non-porous surface with a low surface tension, which means that printer inks and coatings do not adhere easily. A corona treatment changes the surface properties (albeit invisibly), which improves adhesion. This treatment is in principle carried out before any layer such as an adhesive layer or graphic layer is applied to the floor tile.

To obtain an even better adhesion of the UV ink to the plastic of the floor tile, the tile can first be provided with a primer layer or an adhesive layer. This is preferably based on a water-borne adhesive layer that has been specially developed to increase the adhesive strength of plastics. This adhesive layer may be a two-component (2K) adhesive layer. The adhesive layer can be applied with a roller, and then cured with UV light.

To ensure very clear print results, a white underlayer can be applied prior to applying the ink. This underlayer can be applied with a roller, and then cured with UV light. If the floor tile itself is already light in color (e.g. white), applying a white underlayer is not necessary to obtain a very clear print result. This underlayer may be the same layer as the above-mentioned adhesive layer. The adhesive layer may, when the floor tile has a light color, also be transparent, to still obtain the advantageous adhesive properties of the layer.

In order to further protect the graphic layer applied with UV printing technology, the inventors have realized that a coating must be applied. It has been found that a polyurethane-based coating, which is in particular an acrylate polyurethane, and which is preferably water-borne and comprises 2 components, forms a very strong protective layer for the graphic layer. This coating layer is so strong that a robust, durable graphic image can be obtained, while the necessary nonskid properties are provided by applying an nonskid material, while these do not cause wear to the graphic layer, as is the case with currently known floor tiles. The nonskid material is encapsulated by the coating, at least on the side of the floor tile, in such a way that these sharp particles (such as sand or similar material) cannot affect the print.

It is possible to first apply an base coat beneath the protective coating for extra protection. Both the base coat and the protective coating can be cured with UV light. The base coat is then cured before the protective coating is applied.

In an example, an adhesive layer is included between the graphic layer and the main face of the floor tile to improve the adhesion of the graphic layer to the main face of the floor tile.

In an example, the protective coating comprises a two component polyurethane acrylate coating which is water-borne.

In an example, the floor tile comprises polypropylene.

In an example, the floor tile comprises polyethylene.

In an example, the floor tile comprises masterbatch.

In an example, the floor tile is provided with a surface profile on the main face to provide grip for users of the field.

In an example, the floor tile comprises on the main face an at least partially open structure for providing water permeability of the floor tile.

In an example, the floor tile further comprises one or more fastening elements, which fastening elements are arranged to connect the floor tile to one or more further floor tiles.

In an example, the fastening elements are provided with in interlocking parts or deformable material for allowing expanding and contracting of the tile with temperature variations.

In a second aspect, a method is provided for manufacturing of a floor tile for use as a construction element for manufacturing a field such as a sports or playing field, the method comprising the steps of:
manufacturing the floor tile from a plastic material, wherein the floor tile is manufactured using injection molding technology;
treating a main face which is oriented upwards after manufacture of the field and is visible to users of the field with a corona treatment;
applying an adhesive layer to a main face which is oriented upwards after manufacture of the field and which is visible to users of the field;
applying to the adhesive layer a graphic layer which is arranged to provide marking lines, logos, graphics or coloring of the tile, and which comprises UV ink,
applying a protective coating to the graphic layer, wherein the coating is provided with nonskid means,
wherein the adhesive layer is a plastic adhesive layer, the graphic layer is applied using a Light Emitting Diode, LED, Ultra Violet, UV, flatbed printer, and wherein the protective coating comprises a two-component polyurethane coating which is water-borne.

In an example, the steps of applying the adhesive layer, the graphic layer and the protective coating are performed by a single machine.

In an example, the floor tile is made of polypropylene.

In an example, the floor tile is made of polyethylene.

In an example, masterbatch has been added to the plastic of the floor tile.

In an example, the plastic comprises both virgin plastic material and recycled plastic material.

In general, sports floors have to meet standards EN14877 and EN14904 for indoor and outdoor sport applications. In the context of the present invention antiskid and abrasion resistance are specifically important. Floor tiles with a print according to the present invention turn out to meet the above mentioned standards, and have in particular improved antiskid properties and abrasion resistance compared to floor tiles not according to the present invention.

The invention will be further elucidated below on the basis of the description of a number of embodiments of the invention with reference to the following figures, in which

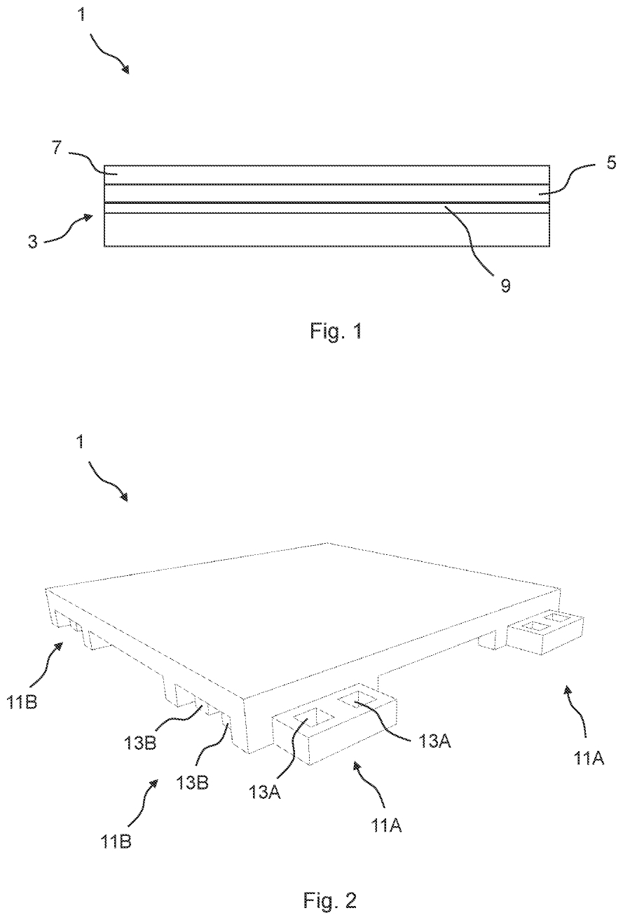

FIG. 1 shows a first embodiment of a transverse view of a floor tile;

FIG. 2 shows a perspective view of the floor tile provided with fastening elements according to an exemplary embodiment of the present description;

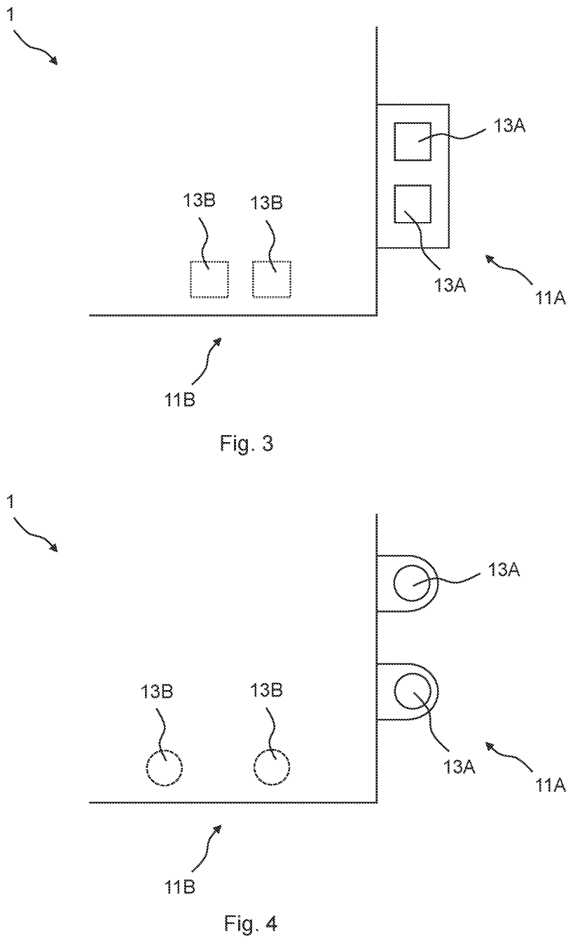

FIGS. 3 and 4 show top views of various fastening elements according to exemplary embodiments of the present description;

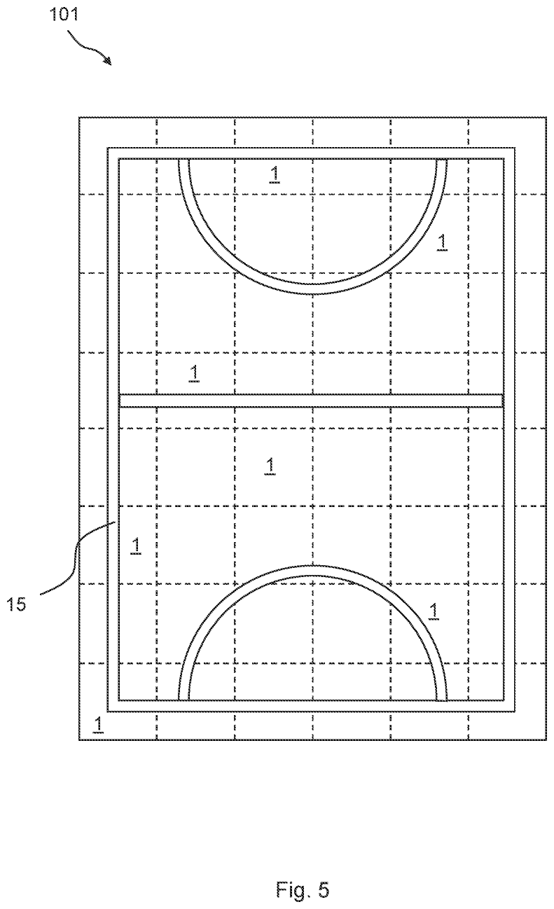

FIG. 5 shows a top view of a sports field constructed from several floor tiles according to the present description;

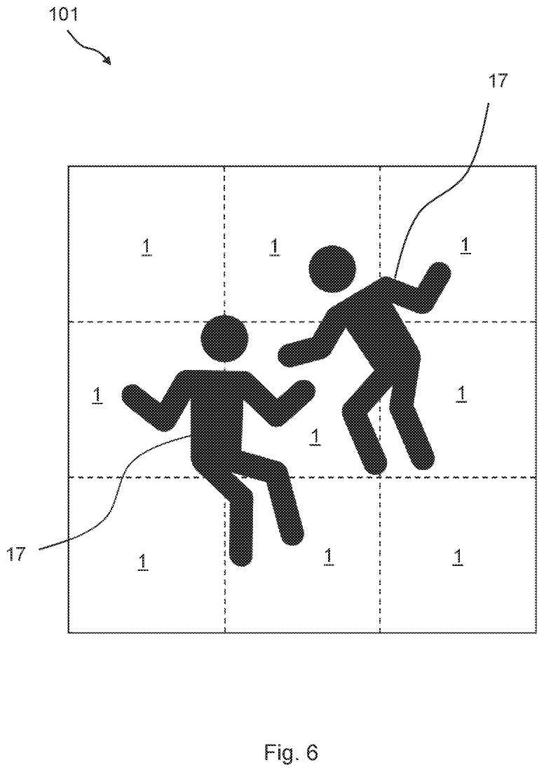

FIG. 6 shows a top view of a sports field made up of a plurality of floor tiles according to the present description;

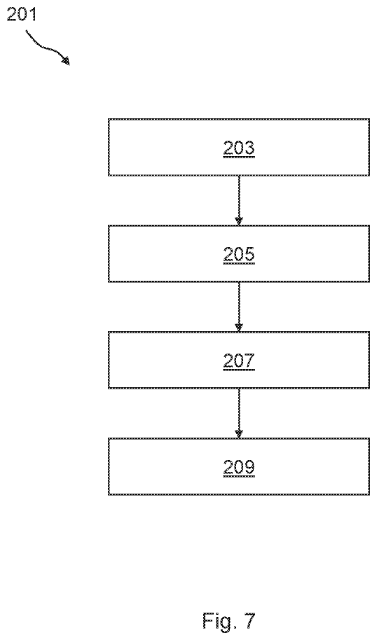

FIG. 7 shows a flow chart of the steps of manufacturing a floor tile according to the present description.

FIG. 1 shows a cross-section of a floor tile 1 according to an aspect of the present description. The tile 1 is made up of various layers 3, 5, 7, 9 and is suitable for use as a construction element for a field, which means that a field such as a sports field can be constructed with such tiles as building blocks in a simple manner. The tile is also suitable for a playing field or other technical field for use indoors or outdoors under various weather conditions.

The tile comprises several layers and comprises at least a first base layer 3 or carrier layer. This layer determines for a large part the sports or game properties of the field and is therefore preferably manufactured from a material suitable for this purpose, such as a plastic, and more in particular a polypropylene or polyethylene plastic. This plastic can be completely colored, which means that not only an upper layer applied thereto is provided with coloring, but that the entire tile is colored through-and-through. To this end, this base layer 3 or substrate 3 can be provided with masterbatch and/or color pigment(s).

Characteristic of the tile is that it is provided with a graphic layer 5. A graphic layer is understood to mean a layer which comprises an image, drawing, pattern, color or other type of graphic element or elements applied thereon. This layer 5 is applied, for example, with the aid of a Light Emitting Diode, LED, Ultra Violet, UV, flatbed printer. This is particularly suitable for applying all kinds of graphic representations to the base layer 3.

In order to better protect the graphic layer 5 against wear, which can occur to a large extent due to intensive use as a sports or playing field, the tile 1 is provided with an extra protective layer or protective coating 7. This protective coating ensures that the graphic layer becomes a lot more durable and is so robust that it can withstand the high intensity of use during sports and play activities. The coating 7 is preferably a two-component polyurethane coating and water-borne.

Because the coating 7 provides a smooth finish, it is further provided with nonskid means, i.e. nonskid material can be incorporated in the coating when the coating is applied. This nonskid improves the skid resistance of the tile and protects it even further against wear. The nonskid can be applied in various forms, which means that it can increase skid resistance due to the intrinsic properties of the material, but also due to its shape and size. Examples of suitable nonskid material are sand grains, crushed stone grit or synthetic particles. As indicated, the nonskid can also be provided by the intrinsic properties of the material. For example, a polyurethane layer can have nonskid properties and be sufficiently nonskid by nature, depending on the application or the type of game or sport for which the tile is intended. Also, the nonskid can be provided by a profile of the coating, i.e. the coating is applied in such a way that relief is provided so that more grip is created for the users of the field.

The tile 1 is shown in FIG. 1 in cross-section with the lower layer having a first and second major face. The first main face 3 is oriented upwards, i.e. the side facing the graphics layer 5 and the coating layer 7 forms the visible side and is intended to be oriented upwards in use. The opposite side or the second main face is oriented towards the ground and has a load-bearing function. This bottom side is shown in FIG. 1 as a flat side, but it can also have a certain structure, for example in the form of a pattern of bulges or notches, which can provide architectural properties such as better anchoring to the substrate, and/or simplifying of the tile installation.

In order to allow the graphic layer, which can be applied with the aid of a (UV) flatbed printer, to adhere even better to the base layer 3, it is further provided with a primer 9 or an adhesive layer 9. This is included to improve adhesion of the graphic layer 5 to the main face 3 of the floor tile 1.

The floor tile 1 can be designed to be water-permeable, i.e. the water that ends up on the upper side of the coating layer 7 can drain through the tile 1 to the substrate under the base layer 3. To this end, the tile can be provided with a water-permeable structure, for instance in that each layer consists of an open cell structure, or in that one or more layers are provided with holes after manufacturing to promote water permeability. Moreover, the design can also make the tile suitable for increasing the water permeability. For example by having a slightly convex upper side, so that water flows off to the edges of the tile and/or because the tile is provided with drainage facilities on the periphery, such as a gap between the tiles.

The floor tiles 1 according to the present description are designed to be mutually fastened. For this purpose they are provided with one or more fastening elements 9A, 9B. These are shown in FIG. 2. The fastening elements 9A, 9B shown there are only a single example and the skilled person will understand that various types of fastening elements are suitable. Preferably, the fastening elements are provided in the form of elements corresponding in shape and size so that protrusions of one element 11A fit into a recess of a corresponding element 11B and thus engage and fixate the tiles.

FIG. 2 shows an example of fastening elements 11A, 11B, wherein the fastening elements are arranged on each side of the tile 1, and more in particular two fastening elements contrasting in shape are provided at each corner. These comprise, for example, two recesses 13B which fit into the openings 13A to anchor in this way.

FIG. 3 shows a top view of these fastening elements 11A, 11B and their position on the floor tile 1. It can again be clearly seen that these, in the variant shown here, with again emphasizing that there are also other variants that fall under the embodiments of the present floor tile 1, are provided with corresponding or mating connections on different sides of the tile 1. In addition, other mating connections or fixating elements are also possible, such as various types of pin-hole connections or other form locks such as hook connections, tongue-and-groove connections, dovetail connections, spline connections. Power locks such as wedges or detachable pin connections are also possible.

The shown, or other not shown but falling under the present description, fastening elements 11A, 11B are further preferably designed to allow the floor tile 1 to expand and contract. In this way, material expansion as a result of temperature variations can be accommodated. To this end, the fastening elements 11A, 11B can for instance have some slack, because the pin connections 13B are smaller than the corresponding holes 13A. They may also comprise material which is suitable for absorbing any movement, i.e. expansion, and therefore be made, for example, of a deformable material.

In FIG. 4, another example of fastening elements 11A, 11B is shown, which has different shapes and provides round pin 13B and hole 13A connections.

FIG. 5 shows a field 101 which is made up of a plurality of floor tiles 1. Depending on the size of the tiles 1 and the field 101, less or more tiles 1 can be used. In the example shown, the field 101 is a sports field 101 provided with various marking lines 15. These marking lines extend across various tiles 1 and are applied in accordance with the present description with the aid of a printing technique. The UV printers used for this purpose comprise a UV lamp that causes the applied UV ink of the graphic layer 5 to harden directly on the base layer 3, see FIG. 1. Moreover, the UV printing technique is particularly suitable to directly print with structure or relief, allowing direct provision of the nonskid properties during the printing process and requiring no further post-processing. The used UV ink may be rigid after curing but may also retain some degree of flexibility to better withstand wear and tear under extreme field loads.

Because the marking lines are applied as a graphic layer per tile 1, it becomes possible to display all kinds of graphic elements and there are, therefore, in fact no limits to what is applied to the tile. This also makes complex marking lines and strong contrasts and clean lines possible. In addition, an marking can be placed on each tile in a visible manner or out of sight, thereby simplifying installation. For example, the tiles can be provided with ascending numbering, so that when the field is installed, the tiles can easily be placed by number and the marking lines are provided in the correct manner.

Marking lines as shown in FIG. 5 are only one of the many possibilities of graphics that can be applied to the tiles 1. In FIG. 6, another example is shown in which an image of two people 17 is displayed over several tiles. Thus, for example, a field 101 can be designated as a playing field. The application of a field in a public space can also be indicated in a simple manner, for instance by means of an image or indication of the sport for which the field is intended.

FIG. 7 shows the various steps of a method 201 for manufacturing a floor tile 1 for use as a construction element for manufacturing a field 101 such as a sports or playing field, according to the various examples of the present description. To this end, the method comprises various steps.

In a first step, 203, the floor tile 1 is provided from a plastic material, wherein the floor tile 1 is manufactured using injection molding technology and is preferably manufactured from polypropylene or polyethylene and moreover preferably comprises masterbatch.

The plastic used can be both new material and (completely or partly consisting of) recovered plastics.

In a second step, 205, an adhesive layer 9 is applied on the main face 3 of the floor tile 1, that is oriented upwards after manufacture of the field and visible to users of the field 101, which is a plastic adhesive layer or a primer and improves adhesion of the afterwards following graphic layer to the floor tile.

The graphic layer is applied to the adhesive layer in step 207, wherein the graphic layer is arranged to provide marking lines, logos, graphics or coloring of the floor tile 1 as shown, for example, in one of the FIGS. 5 and 6. This graphic layer comprises a UV ink and is applied directly to the floor tile 1 using a Light Emitting Diode, LED, Ultra Violet, UV, or flatbed printer.

Subsequently, in step 209, a protective coating 7 is applied to this graphic layer, wherein the coating is provided with nonskid means and wherein the protective coating 7 comprises a two-component polyurethane coating which is water-borne.

The application of the adhesive layer, the graphic layer and the protective coating can subsequently be performed by one and the same machine or printer, but can also be applied by several separate machines.

1. A floor tile arranged for use as a construction element for the manufacture of a field such as a sports or playing field, the floor tile comprising a main face which is oriented upwards after manufacture of the field and is visible to users of the field, wherein the floor tile is a plastic floor tile and on the main face is provided with a graphic layer which is arranged to provide marking lines, logos, graphics or coloring of the floor tile, the graphic layer comprising UV ink, as well as a protective coating applied to the graphic layer, the protective coating comprising a two-component polyurethane coating provided with nonskid material, wherein the main face has been pre-treated by of a corona treatment.

2. The floor tile according to claim 1, wherein a base coating is included between the graphic layer and the protective coating.

3. The floor tile according to claim 1, wherein a white underlayer is included between the graphic layer and the main face of the floor tile.

4. The floor tile according to claim 1, wherein between the graphic layer and the main face of the floor tile or between the white underlayer and the main face of the floor tile an adhesive layer is included for improving the adhesion of the graphic layer or the white underlayer to the main face of the floor tile.

5. The floor tile according to claim 1, wherein the protective coating comprises a two-component polyurethane acrylate coating which is water-borne.

6. The floor tile according to claim 1, wherein the floor tile comprises polypropylene and/or polyethylene.

7. The floor tile according to claim 1, wherein the floor tile comprises masterbatch.

8. The floor tile according to claim 1, wherein the floor tile is provided with a surface profile on the main face for providing grip for users of the field.

9. The floor tile according to claim 1, wherein the floor tile comprises an at least partly open structure on the main face for providing water permeability of the floor tile.

10. The floor tile according to claim 1, further comprising one or more fastening elements, which fastening elements are arranged to attach the floor tile to one or more further floor tiles, preferably wherein the fastening elements are provided with interlocking parts or deformable material for allowing the floor tile to expand and contract with temperature variations.

11. A method for manufacturing a floor tile for use as a construction element for manufacturing a field such as a sports or playing field, the method comprising the steps of:
manufacturing the floor tile from a plastic material, wherein the floor tile is manufactured using injection molding technology;
treating a main face which is oriented upwards after manufacture of the field and is visible to users of the field with a corona treatment;
applying an adhesive layer to a main face which is oriented upwards after manufacture of the field and is visible to users of the field;
applying to the adhesive layer a graphic layer which is arranged to provide marking lines, logos, graphics or coloring to the floor tile, and comprising UV ink;
applying a protective coating to the graphic layer, wherein the coating is provided with nonskid material means;
wherein the adhesive layer is a plastic adhesive layer, the graphics layer is applied using a Light Emitting Diode, LED, Ultra Violet, UV, flatbed printer, and wherein the protective coating comprises a two-component polyurethane coating which is water-borne.

12. The method according to claim 11, wherein a white underlayer is applied to the adhesive layer prior to the application of the graphic layer.

13. The method according to claim 11, wherein an base coat is applied to the graphic layer before applying the protective coating.

14. The method according to claim 11, wherein the steps of applying the adhesive layer, the graphic layer and the protective coating are performed by a single machine.

15. The method according to claim 11, wherein the floor tile is manufactured from polypropylene or polyethylene.

16. The method according to claim 11, wherein masterbatch has been added to the plastic material of the floor tile.

17. The method according to claim 11, wherein the plastic comprises both virgin plastic material and recycled plastic material.
